(19) United States
(12) Patent Application Publication
(10) Pub. No.: US 2007/0221836 A1
(43) Pub. Date: Sep. 27, 2007

(54) Mass analysis system

(76) Inventors: Kinya Kobayashi, Hitachi (JP); Kiyomi Yoshinari, Hitachi (JP); Toshiyuki Yokosuka, Hitachinaka (JP); Atsumu Hirabayashi, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/698,105

(22) Filed: Jan. 26, 2007

(30) Foreign Application Priority Data
Mar. 24, 2006 (JP) 2006-081899

(51) Int. Cl. B01D 59/44

(52) U.S. Cl. 250/282

(57) ABSTRACT

An object of the present invention is to evaluate quantitatively a peptide derived from a protein, whose analysis has been difficult so far, by analyzing a peptide ion derived from a protein already measured but having a different total ion amount as the tandem mass analysis target at the time of quantitatively evaluating a fluctuating component between different kinds of specimens by the tandem mass analysis of a protein or a peptide. In the present invention, in order to achieve the above-mentioned object, data of a derived peptide obtained by a first time measurement are stored automatically in an internal database and collated with second time measurement data highly accurately. The processing for selecting the peak of the already measured peptide with the relative amount fluctuation as the next tandem analysis target is implemented within the real time of the measurement for avoiding the analysis of a peptide without the relative amount fluctuation.

### BACKGROUND OF THE INVENTION

1. Field of the Invention

The present invention relates to an analysis system for mass analysis spectra using a mass analysis apparatus, and in particular, it relates to a system for the automatic judgment of the optimum mass analysis flow within the real time of the measurement for accurately and efficiently identifying the fluctuation amount of a minute amount of the biopolymers such as peptides and sugar chains.

2. Description of the Related Art

According to a common mass analysis method, after ionizing a specimen as the measurement subject, the various produced ions are sent to the mass analysis apparatus for measuring the ion intensity for each mass to charge ratio m/z as the ratio of the mass number m of the ion to the valence number z. The mass spectra obtained as a result are consisted of the peaks of the measured ion intensities (ion peaks) with respect to each mass to charge ratio m/z value. The mass analysis of the ionized specimen as it is is referred to as MS¹. According to a tandem type mass analysis apparatus capable of carrying out the multiple stage dissociation, out of the ion peaks detected by the MS¹, by selecting an ion peak having a specific mass to charge ratio m/z value (the selected ion specie is referred to as the parent ion), and furthermore, separating and dissociating the ion by collision with the gas molecules, or the like, and carrying out the mass analysis with respect to the produced dissociated ion specie, the mass spectra can be obtained in the same manner. Here, the n stage dissociation of the parent ion and the mass analysis of the dissociated ion specie is referred to as MSⁿ⁺¹. According to the tandem type mass analysis apparatus, by dissociating the parent ion in multiple stages (first stage, second stage, . . . , nth stage), the mass number of the ion specie produced in each stage is analyzed (MS², MS³, . . . , MSⁿ⁺¹).

In the case of evaluating the difference of the same ion specie between two kinds of specimens, using the mass analysis system, a method of labeling isotopically one of the specimens is used in many cases. However, this method can hardly be used for a specimen, which cannot be labeled isotopically. There is a software capable of analyzing the fluctuation=difference=differential of an ion, in particular, a peptide ion without using the isotope labeling. With the software, the expression difference analysis and the protein identification can be enabled at the same time using the MS¹ and MS² data. Furthermore, the ion as the peak volume can be evaluated.

As mentioned above, the fluctuation amount of the same ion specie in two kinds of specimens is measured as a post process after the all analyses being finished. According to the method of carrying out the same as a post process after the analyses being finished, in the case of the quantitative evaluation of the fluctuation amount of a minute component in the specimen including a large amount of components, the following problems are involved.

First, in the case of carrying out the MSⁿ⁺¹ analysis, the MSⁿ ion is selected regardless of the fluctuation amount of the same ion specie present in the two kinds. The ion analysis time per one specimen is constant. Therefore, even in the case the kind of ions between two kinds of specimens is same but the amounts differ significantly, in the case of a minute amount, the MSⁿ⁺¹ analysis may not be carried out, so that the identification may fail. In this case, since the re-measurement is needed, the measurement operation may be prolonged.

Second, since the MSⁿ ion intensity cannot be measured at the time of the MSⁿ⁺¹ analysis, the quantitative evaluation of the MSⁿ cannot be carried out in this period, which leads to deteriorate the quantitative accuracy of the MSⁿ.

### SUMMARY OF THE INVENTION

The present invention is for solving the problems, and an object thereof is to judge the subsequent analysis content of selection of the parent ion at the time of executing the MSⁿ⁺¹ analysis within the real time of the measurement highly efficiently and highly accurately, by effectively utilizing the information included in the MSⁿ spectra in each stage of the MSⁿ.

In the present invention, in order to solve the above-mentioned problems, the following means are adopted in a mass analysis apparatus capable of carrying out the tandem analysis.

During the MSⁿ mass analysis measurement the mass analysis spectrum information of the ion specie from the appearance of an ion specie to passage of t seconds (mass, valence number, retention time, time dependency) is stored in the database in the apparatus. At the same time, by comparing the information of the all ion species stored in the data base, whether or not there is an ion specie with the mass, valence number and retention time coinciding therewith with some tolerance (hereinafter, it is referred to as the same ion specie) is searched for. In the case such an ion specie is found, the temporal change of the mass analysis spectrum being analyzed at the time (lateral axis: mass to charge ratio, vertical axis: ion intensity) and the mass analysis spectrum stored in the data base is calculated, and only in the case the correlation value is same as or less than a standard value, the ion specie is selected as the parent ion for the MSn analysis. Furthermore, during the mass analysis measurement, by calculating the total count number A(t) from the appearance of the ion specie to the passage of t seconds, and comparing with the A(t) of the same ion specie stored in the data base of the apparatus, only in the case the ratio between the two is same as or less than a standard value or same as or more than the same, the ion specie is selected as the parent ion for the MSⁿ⁺¹ analysis. Moreover, the total ion amount in the MSⁿ⁺¹ analysis for carrying out the MSⁿ analysis is measured at certain time intervals after passage of the time with the maximum count number of the same ion specie in the data base stored in the apparatus for storing the measurement value in a memory and storing the same in a hard disc after passage of a certain time.

It is not the absolute value of the total count number or the integration value, but it is the relative value of the total count number or the integration value to another standard ion specie included in the specimen.

Thereby, high speed analysis of the mass spectrum (MSⁿ) obtained by dissociating a target ion by an n-1 times and carrying out the mass analysis can be enabled within the real time of the measurement.

According to the present invention, a mass analysis apparatus capable of enabling the quantitative analysis of a minute fluctuation amount between the specimens desired by a user without wasting the measurement time can be realized.

### BRIEF DESCRIPTION OF THE DRAWINGS

FIG. 1 is a chart schematically showing the flow of the mass analysis flow automatic judging process in the present invention.

FIG. 2 is a chart schematically showing the entirety of a mass analysis system for measuring the mass analysis data in the present invention.

FIG. 3A is a graph showing a conventional multiple stage dissociation mass analysis flow.

FIG. 3B is a graph showing a multiple stage dissociation mass analysis flow of the present invention.

FIG. 3C is a graph showing a multiple stage dissociation mass analysis flow of the present invention.

FIG. 4 is a chart showing an example of the storage content of the internal database used in the present invention.

FIG. 5 is a graph showing an example of an execution timing in the case of carrying out within the real time of the mass analysis measurement of the present invention.

FIG. 6A is a chart showing the target selecting method in the example 2 of the present invention.

FIG. 6B is a chart showing the target selecting method in the example 2 of the present invention.

FIG. 7 is a diagram schematically showing the entirety of the mass analysis system in the example 3 of the present invention.

FIG. 8 is a diagram schematically showing the entirety of the mass analysis system in the example 4 of the present invention.

FIG. 9 is a diagram schematically showing the entirety of the mass analysis system in the example 5 of the present invention.

FIG. 10 is a diagram schematically showing the entirety of the mass analysis system in the example 6 of the present invention.

FIG 11 is a graph schematically showing the analysis flow in the example 8 of the present invention.

FIG. 12 is a graph schematically showing the analysis flow in the examples 9, 10 of the present invention.

FIG. 13 is a graph schematically showing the target selecting method in the example 11 of the present invention.

FIG. 14 is a graph schematically showing the target selecting method in the example 12 of the present invention.

FIG. 15 is a chart showing the RT information correcting flow of the internal DB in the example 13 of the present invention.

FIG. 16 is a chart showing the relationship between the RT displacement and the ion intensity in the example 13 of the present invention.

FIG. 17 is a chart showing the intensity information correcting flow of the internal DB in the example 14 of the present invention.

### DESCRIPTION OF THE PREFERRED EMBODIMENTS

Hereinafter, with reference to the drawings, the examples of the present invention will be explained.

### EXAMPLE 1

Hereinafter, the first example of the present invention wilt be explained.

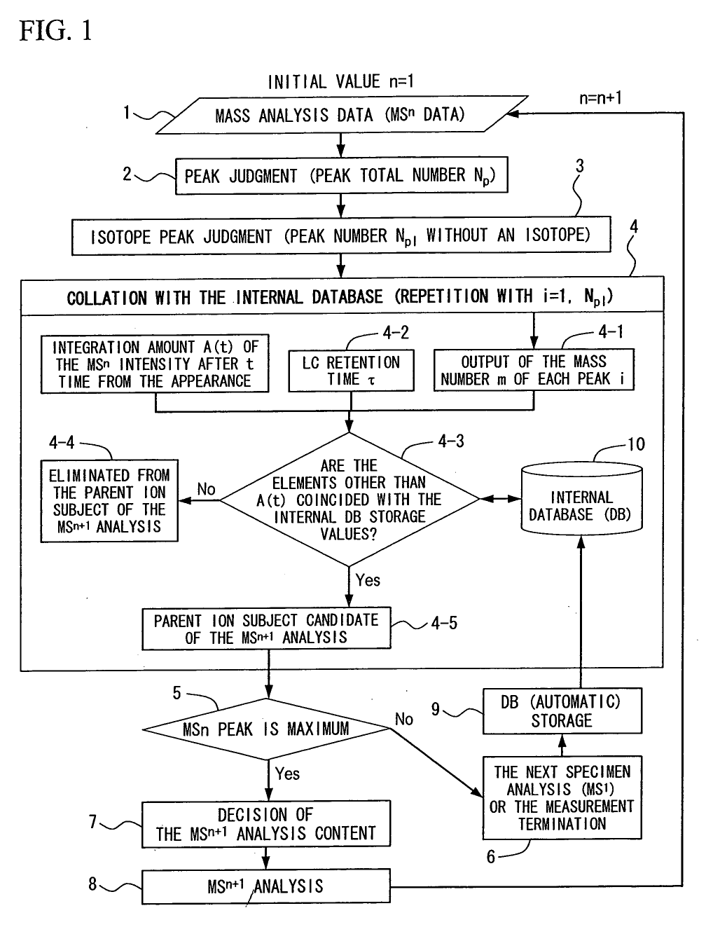

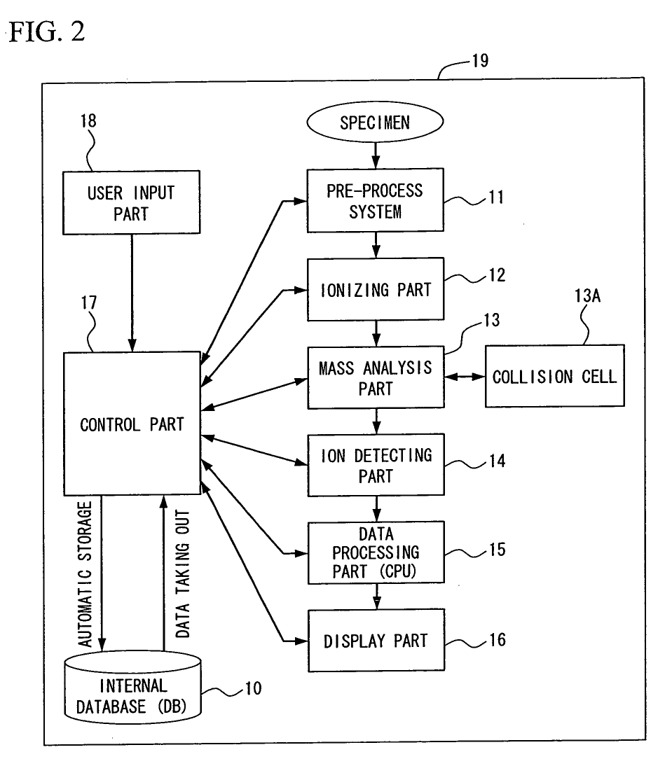

FIG. 1 is a flow chart of the automatic judging process of the analysis content in a mass analysis system as the first example of the present invention. The mass analysis data 1 refers to the data measured by the mass analysis system 19 shown in FIG. 2. In the mass analysis apparatus 19, the specimen as the analysis subject is pre-processed by a pre-process system 11 such as a liquid chromatography. For example, in the case of a protein as the original specimen, it is decomposed to the size of a polypeptide by a digestive enzyme so as to be separated and sectioned by the liquid chromatography (LC) in the pre-process system 11. Thereafter, it is ionized in an ionizing part 12, and separated according to the mass to charge ratio m/z of the ion in a mass analysis part 13. Here, m is the ion mass, and z is the charge valence number of the ion. The separated ion is detected in an ion detecting part 14, and its data arrangement and processing is performed in a data processing part 15, and then the mass analysis data 1 as the analysis result are displayed at a display part 16. A control part 17 controls the entirety of the series of mass analysis process—ionizing of the specimen, transportation and input of the specimen ion beam to the mass analysis part 13, the mass separation process, and the ion detection, data processing. In the mass analysis method, there are a method of ionizing a specimen and analyzing the same as it is (MS analysis method), and a tandem mass analysis method of mass selection of a specific specimen ion (parent ion), and carrying out the mass analysis of a dissociated ion produced by dissociating the same. The tandem mass analysis method has also a function of carrying out the dissociation and the mass analysis multiple stages (MSⁿ) of selecting an ion having a specific mass to charge ratio (precursor ion) out of the dissociated ion, and furthermore, dissociating the precursor ion for carrying out the mass analysis of the dissociated ion produced at the time. That is, the dissociation and the mass analysis are carried out in multiple stages (MSⁿ(n≧3)) by for example measuring the mass analysis distribution of a substance in an original specimen as mass spectrum data (MS¹), selecting a parent ion having a certain m/z value, dissociating the same, measuring the mass analysis data of the resultant dissociated ion (MS²), further dissociating the selected precursor ion out of the MS² data, and measuring the mass analysis data (MS³) of the resultant dissociated ion. The molecular structure information of the precursor ion in a state before the dissociation can be obtained for each dissociation stage so that it is extremely effective for presuming the precursor ion structure. The presumption accuracy at the time of presuming the parent ion structure as the original structure can be improved more as the structure information of the precursor is in more detail.

In this example, first, the case of adopting a collision induced dissociation method of dissociating by the collision with a buffer gas such as a helium as the precursor ion dissociating method will be mentioned. Since a neutral gas such as a helium gas is necessary for the collision dissociation, as shown in FIG. 2, although a collision cell 13A for the collision dissociation may be provided independently of the mass analysis part 13, collision dissociation may be carried out in the mass analysis part 13 filled with a neutral gas. In this case, the collision cell 13A is unnecessary. Moreover, as the dissociating means, the electron capture dissociation of dissociating the target ion by directing low energy electrons toward it and by having the parent ion capture the low energy electrons by a large amount, may be adopted.

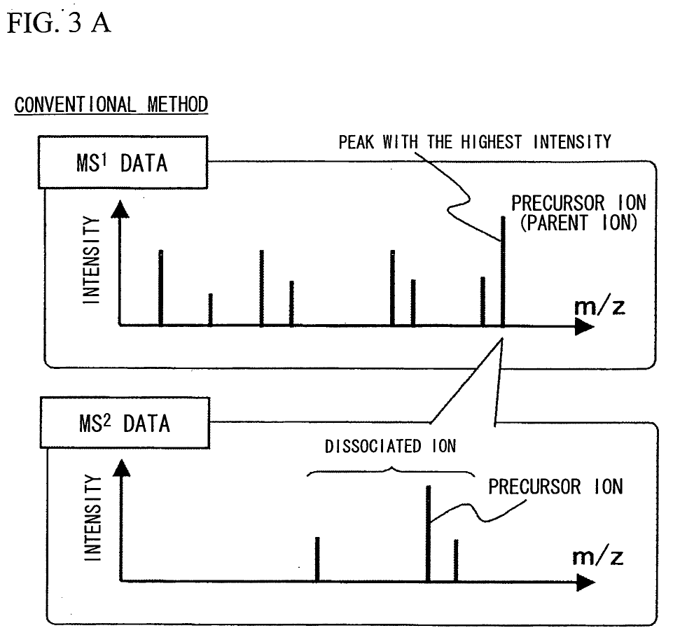

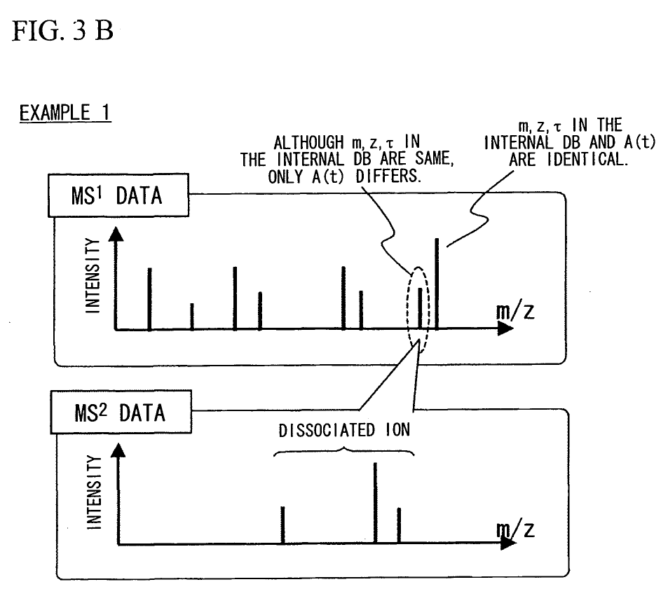

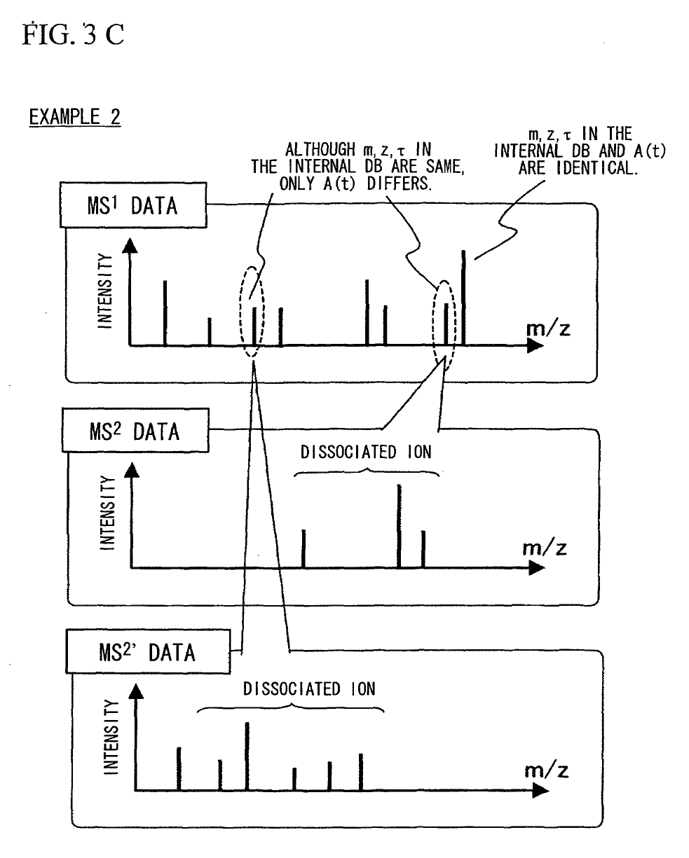

FIG. 3A shows the automatic judging method of the tandem mass analysis flow according to a conventional technique. Out of the spectra in the MS¹ as the mass analysis distribution of the substances in the specimen, a target (parent ion) to be further dissociated for the mass analysis is selected. At the time, in the case of selecting from the order of the high intensity peak, also at the time of selecting the precursor ion of the MS² or thereafter, the high intensity ion peak has been selected in the same manner. According to such a tandem mass analysis flow automatic judging method, for example, in the case the specimen is a protein, a peptide ion obtained by enzymatic decomposition from the protein expressed by a large amount can easily be the target of the tandem mass analysis. Therefore, only the protein expressed by a large amount can be analyzed repeatedly at a high risk.

Then, in the present invention, whether or not the mass number m of the total peptides expected to be produced at the time of the enzymatic decomposition of a preliminarily designated protein, the LC retention time, the ion total amount A(t) from the appearance of the subject peptide ion to the t time, each ion peak value of the measured MS¹ and the value of the peak stored in the internal DB coincide with each other is judged, and based thereon, the parent ion to be the target of the subsequent tandem mass analysis is automatically judged within the real time of the measurement(for example, within 30 msec). For example, in the case the protein A expressed by a large amount is already measured and identified, and fluctuation of only a protein of a minute amount is the subject of the quantitative analysis by the tandem mass analysis, as shown in FIGS. 3B and 3C, the peak with its ion coinciding in m, z, and τ (retention time) but not in A(t) alone is selected with priority among the data stored in the internal data base 10. Thereby, the ion peaks with a low intensity can be selected as the next target of the tandem mass analysis. Here, in the user input part 18 of FIG. 2, in addition to the kind of the digestive enzyme, the user can also input preliminarily whether or not the isotope peak judgment is necessary, whether or not both collation with and retrieval from the internal data base are necessary, the resolution performance at the time of selecting the parent ion, and the like.

Furthermore, in this example, as the characteristics data of the ion specie to be designated preliminarily, the mass number is used instead of the mass to charge ratio m/z. In the case the mass to charge ratio m/z is utilized as the data to be collated, an ion specie coinciding in the m/z value but neither in the mass number m of the ion specie nor in the valence number z is also excepted at the time of selecting the target of the tandem mass analysis. As in this example, if the mass number m is utilized as the data for collation, an ion specie coinciding in the m/z value but neither in the mass number m of the ion specie nor in the valence number z can be distinguished so that the target selection of the tandem mass analysis can be enabled further accurately. Moreover, even in the case of the same ion species (having the same mass number m) but having different m valence numbers and different m/z values, they can be judged as the same ion specie so that the repeated selection as the target of the tandem mass analysis can be avoided.

Furthermore, since there are also different ion species with the same mass number m, the data of the LC retention time τ in the pre process system 11 can also be stored in the internal database 10 so as to be utilized. At the time of having the specimen passing through the LC column, since the equilibrium constant of the adsorption and the desorption to the LC column differs depending on the chemical nature of the substance, the time τ (retention time) taken by the specimen to get out from the column differs. Utilizing this point, even in the case of the different ion species of the same mass number m, if the chemical structures and the chemical natures differ, the LC retention time differs as well, so that the ion species can be distinguished. Therefore, according to this example, since judgment is made on whether or not it is the preliminarily designated ion specie based on the data for specifying the ion species such as the mass number and the LC retention time, analysis can be carried out highly accurately for only the target requiring the tandem mass analysis so that the analysis data can be obtained as the user requests without the wasteful measurement.

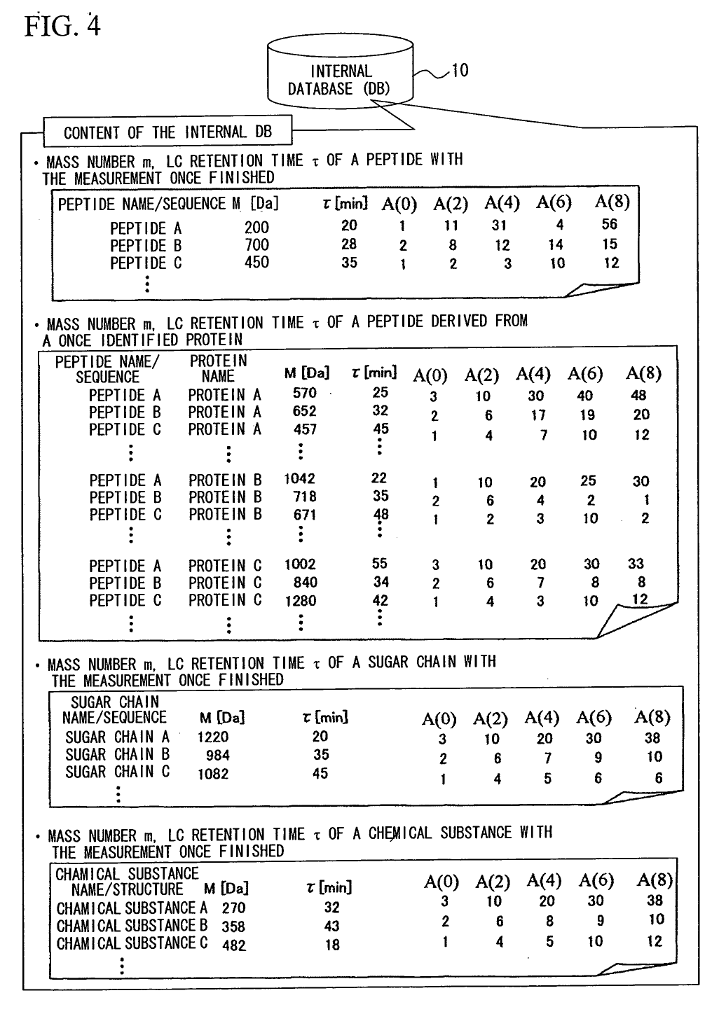

FIG. 4 shows an example of the data stored in the internal database 10 of FIG. 1. As shown in FIG. 4, for example, there are the amino acid sequence, the mass number m, the LC retention time τ, and the total peptide amount A(t) from the appearance to after passage of the t time as to the peptide once measured, the amino acid sequence, the original protein name, the mass number m, the LC retention time τ, and the total peptide amount A(t) from the appearance to after passage of the t time as to the peptide derived from a protein once identified, the sugar chain name or the sugar chain structure, the mass number m, the LC retention time τ, and the total peptide amount A(t) from the appearance to after passage of the t time as to the sugar chain once measured, the chemical substance name or the structure, the mass number m, the LC retention time τ, and the total peptide amount A(t) from the appearance to after passage of the t time as to the chemical substance once measured, or the like. These data are stored automatically in the internal database 10 after the measurement. Although it is preferable to carry out the storing process of these data into the internal data base 10 within the real time of the measurement, in the case the processing amount is large, for example, derivation of peptides from a protein is performed, it may not be carried out within the real time of the measurement. Moreover, in this example, as the following tandem mass analysis, the MSⁿ⁺¹ for selecting the parent ion out of the ion peaks of the MSⁿ and further dissociating the same and carrying out the mass analysis is adopted. Here, judgment 5 on whether or not a parent ion subject candidate is present is carried out, and in the case there is a parent ion subject candidate, in the MSⁿ⁺¹ analysis content deciding process 7, the next MSⁿ⁺¹ parent ion is decided, and moreover, the operation conditions, or the like may be optimized and changed so as to select and dissociate the parent ion with a high efficiency. Moreover, in the case there is no parent ion subject candidate, the analysis (MS¹) of next specimen is performed or the measurement is finished.

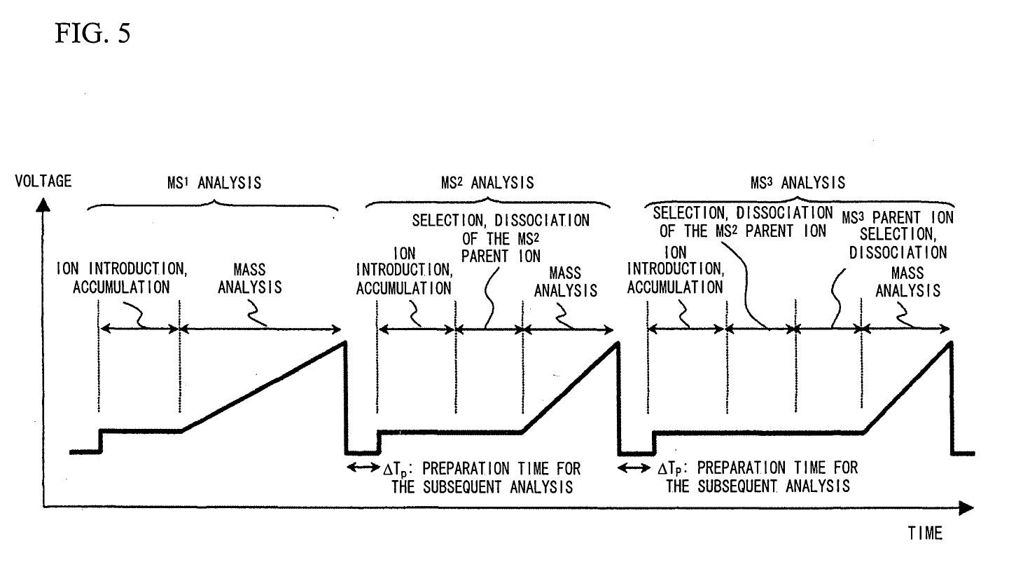

Furthermore, in the present invention, the above-mentioned processing is carried out at a high speed within the real time of the measurement. An example of the real time of the measurement will be explained with reference to FIG. 5. FIG. 5 shows the operation sequence of the apparatus in the case of executing the tandem mass analysis (MS¹, MS², MS³). At the time of moving from MS¹ to MS², from MS² to MS³, a series of the processes shown in FIG. 1 is executed in the preparation time for the following analysis Tp (within about 30 msec). For such a high speed processing, a cash memory and a hard disc are ensured for storing the data necessary for the processing, and if necessary, a parallel computer may be used. According to this example, the MSⁿ spectra can be analyzed at a high speed within the real time of the measurement for judging whether or not it is a target for the following tandem mass analysis MSⁿ⁺¹ in real time highly accurately so that the tandem mass analysis can be enabled for a minute amount of the ion peaks as shown in FIG. 3B.

### EXAMPLE 2

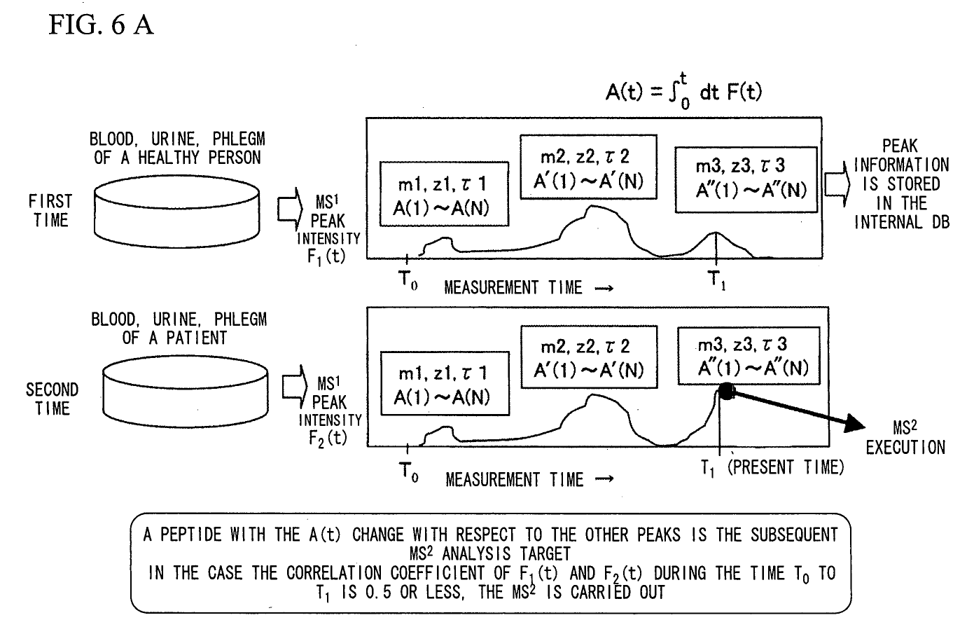

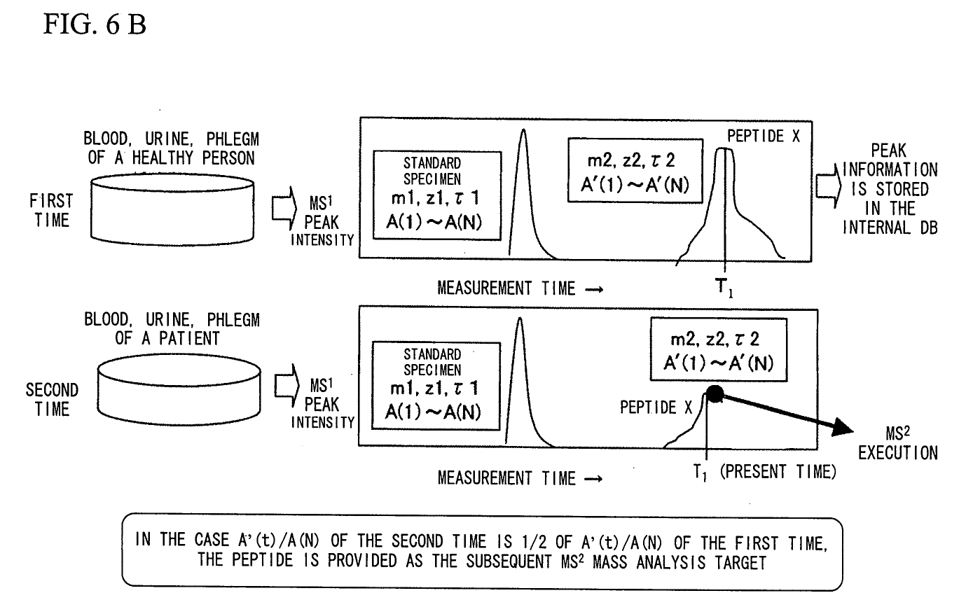

Hereinafter, the example 2 of the present invention will be explained with reference to FIGS. 6A and 6B.

In this example, as the first analysis, the MS¹ analysis data of the peptide derived from the specimen are collected and stored in the internal DB with respect to a living body specimen of a healthy person (blood, urine, phlegm). Then, in the second analysis, the MS¹ analysis data of a living body specimen (blood, urine, phlegm) of a patient are collected. Here, using the internal DB with the specimen of the healthy person stored, in the case the MS¹ peak intensity integrations differ between the two, the peak is selected for the target of the following tandem mass analysis. In FIG. 6A, the first MS¹ peak intensity is F₁(t), and the second one is F₂(t). Here, in the case the correlation coefficients of F₁(t) and F₂(t) between the time T₀ to T₁ (present point) is 0.5 or less in the second measurement, the MS² of the peptide 1 is carried out immediately after the peak intensity becomes maximum. On the other hand, in FIG. 6B, a standard specimen with the same specimen amount is measured for both first time and second time before measurement of the peptide X. Here, with the premise that the integration amount of the standard specimen is A(N), the amount of the peptide X with respect to the standard specimen is A′(T₁)/A(N). In this example, since the A′(T₁)/A(N) in the second time is ½ or less with respect to the first time, the MS² is carried out for the peptide X. The MS² of the peptide X is carried out immediately after the peak intensity becomes maximum. In the case the A′(T₁)/A(N) in the second time measurement is more than ½ of that in the first time measurement, the MS² is not executed.

According to this example, automatic judgment of the peptide derived from the protein, which may be the cause of the disease, and detailed structure analysis can be enabled.

### EXAMPLE 3

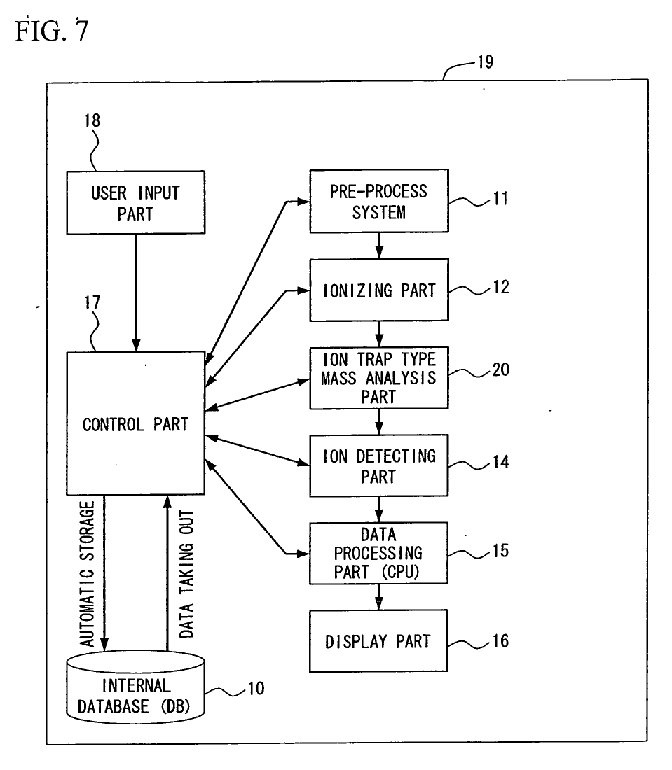

Hereinafter, the example 3 of the present invention will be explained with reference to FIG. 7.

Here, an ion trap type mass analysis part is provided as the mass analysis part. In this case, since the ion trap itself plays the role of the collision cell, the collision cell needs not to be provided independently. Since the tandem analysis MSⁿ can be carried out with n≧3 according to the ion trap, a system of automatically judging the next target as the present invention is extremely effective.

### EXAMPLE 4

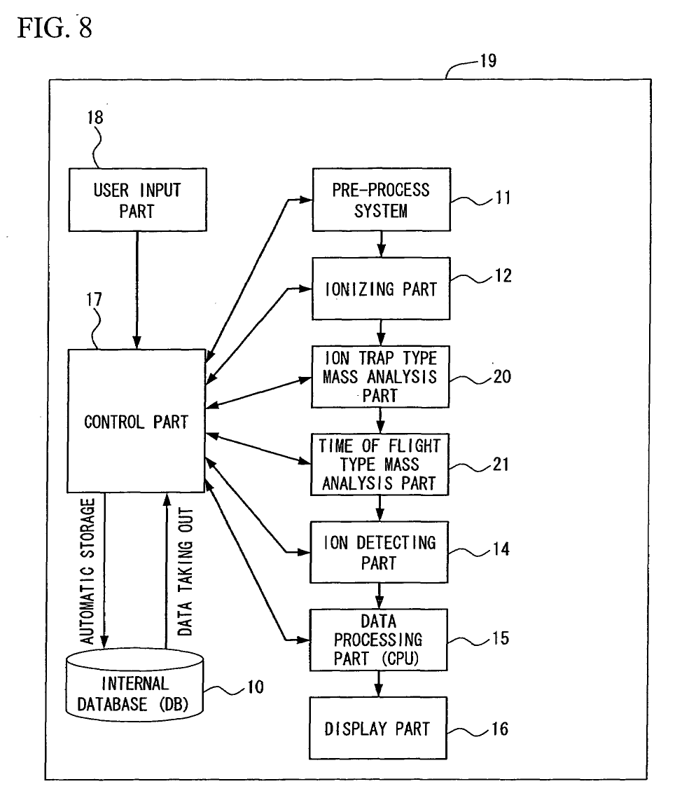

Hereinafter, the example 4 of the present invention will be explained with reference to FIG. 8.

Here, an ion trap—time of flight (TOF) type mass analysis part is provided as the mass analysis part. In this case, the ion trap plays the role of accumulating the ion, selecting the parent ion, and providing a collision cell. The real mass analysis is carried out at the TOF part by the high resolution analysis. In the case the tandem analysis is judged to be necessary by the collation with the internal database of the present invention, the parent ion is selected and dissociated by the ion trap, and the mass analysis is carried out by the TOF. In the case it is judged that the tandem analysis is not necessary, the mass analysis is carried out by the TOF after passing through the ion trap. Therefore, according to this example, since the necessity of the tandem analysis can be judged automatically, the analysis can be enabled with an extremely high efficiency.

### EXAMPLE 5

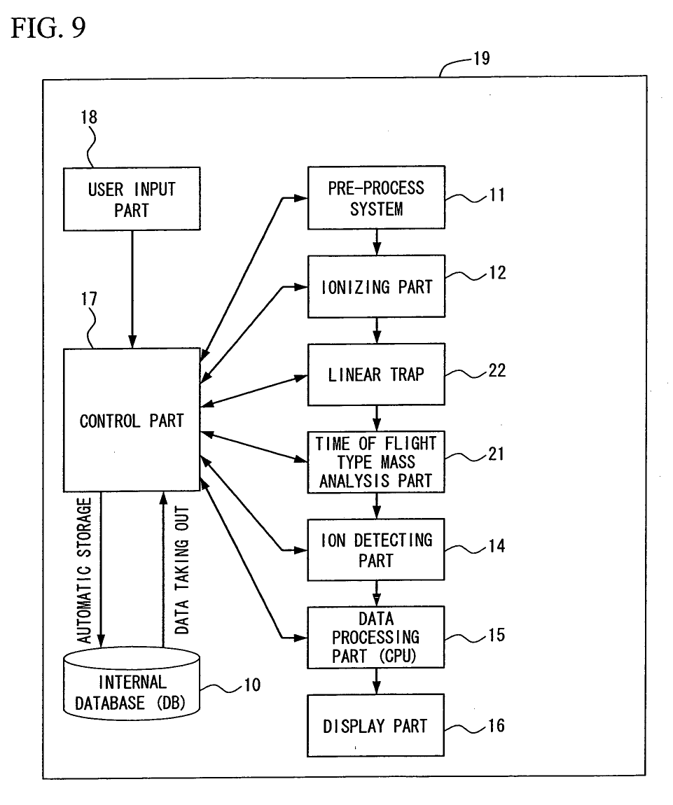

Next, the example 5 of the present invention will be explained with reference to FIG. 9. Here, a linear trap—time of flight (TOF) mass analysis part is provided as the mass analysis part. In this case, the linear trap comprising quadrupole pole-shaped electrodes filled with a neutral gas among the quadrupole electrodes, plays the role of accumulating the ion, selecting the parent ion and providing the collision cell. Compared with the example 4, the ion trap rate is drastically (about 8 times) improved. Therefore, according to this example, since the following analysis content is decided based on the high sensitivity data, judgment can be carried out with an extremely high accuracy.

### EXAMPLE 6

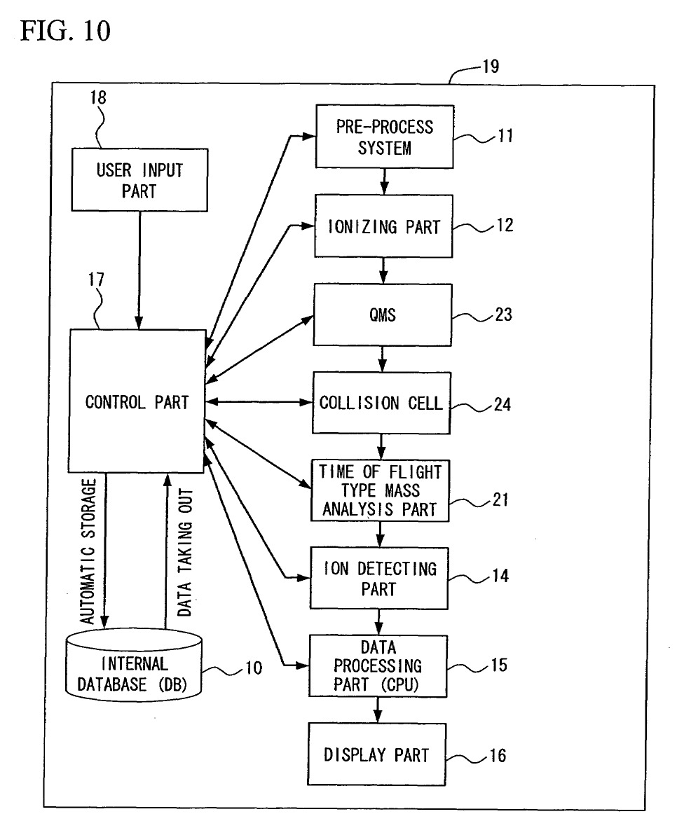

Next, the example 6 of the present invention will be explained with reference to FIG. 10. Here, a quadrupole (Q pole)—collision cell—time of flight type (TOF) mass analysis part is provided as the mass analysis part. According to the mass analysis part of this example, only the process up to the MS² can be carried out basically. However, even in the case the dissociation peak number is insufficient by one time MS², according to this example, the MS² can be carried out repeated with the parent ion changed (in particular, changed to a peak with the same mass number and a different valence number). Moreover, since the necessity thereof can be judged within the real time of the measurement, the mass analysis part of this example enables further dissociation and analysis, which have conventionally been impossible.

Next, as the example 6 of the present invention, in the MS² analysis, the MS² ion amount is integrated in 0.1 second time intervals for storing the result in the memory as needed, and storing the same in the hard disc after passage of 1 second. The MS¹ analysis is carried out before and/or after the MS² analysis. Conventionally, the MS¹ measurement cannot be carried out while executing the MS² so that the quantitative evaluation cannot be enabled. According to the method of this example, since the MS¹ ion time evaluation can be obtained based on both the MS¹ ion amount before and/or after the MS² analysis and the time dependency of the integration amount in the MS² so that the accuracy of the quantitative evaluation can drastically be improved.

### EXAMPLE 7

Next, as the example 7 of the present invention, the mass correction method of the analysis data will be explained. In the shotgun analysis of a protein, or the like, based on the mass analysis result, external data base retrieval of a gene, a protein, or the like is carried out for finally identifying the chemical structure of a biopolymer, or the like. In this case, with a higher mass accuracy of the analyzed ion, the biopolymer can be identified efficiently with a high accuracy. Therefore, for such an analysis, it is important to use a time of flight type (TOF) mass analyzer or a Fourier transform ion cyclotron resonance (FTICR) mass analyzer, which have a relatively high mass accuracy. However, the mass accuracy of for example, the time of flight type (TOF) mass analyzer may be affected by the room temperature of its installation site, or the like. Then, in the case the mass accuracy is fluctuated unexpectedly for some reason, even by carrying out the external database retrieval, the biopolymer cannot be identified accurately. Then, frequently the internal standard substance whose m/z of the detected ion is preliminarily known is analyzed immediately before analysis, to carry out the proofreading of the m/z of the mass analyzer based on the analysis result. However, in the LC/MS of carrying out the analysis for many hours, the mass accuracy may be fluctuated unexpectedly. Then, if a known ion whose mass to charge ratio m/z is preliminarily known is detected out of the ions detected by the mass analysis, the problem can be dealt with by correcting the m/z of the other detected ions based on the information. If a plurality of the known ions is detected, the m/z after the correction can be of an extremely high accuracy. This method involves a problem of the complication because the analysis data are corrected by a sort of the manual operation. However, if the internal data base 10 preliminarily has the information such as the m and the m/z of the ions to be detected, and the LC retention time τ, the known ion to be detected by the MS¹ can be identified using the same. Then, while identifying a plurality of the known ions, the m/z temporal fluctuation can be estimated by the information processing technique so that the m/z of the analyzed ion can be corrected automatically. This means that data of a high mass accuracy can easily be obtained even in the case the mass accuracy of the mass analyzer is fluctuated unexpectedly. Moreover, in the case of using a mass analyzer with such an information processing technique, analysis of the known substances before starting the analysis is not always necessary, so that the burden of the user can be reduced. Accordingly, the information of the internal database 10 is substantially effective for not only the control of the real time tandem mass analysis but also proofreading or correction of the m/z of the analysis data.

### EXAMPLE 8

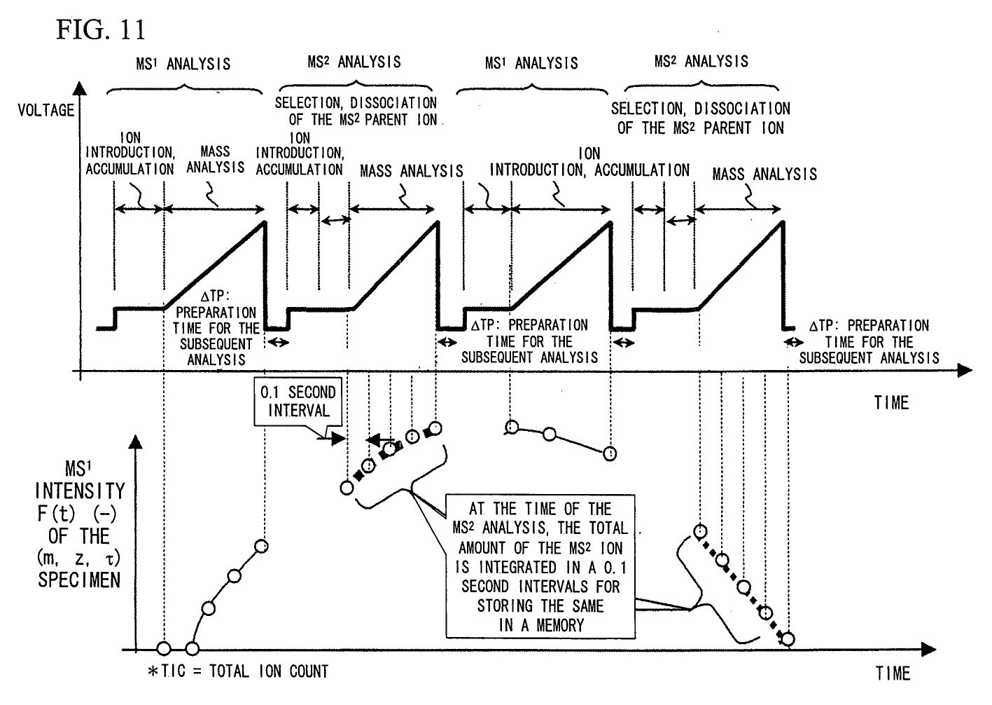

Next, the example 8 of the present invention will be explained with reference to FIG. 11. As shown in FIG. 11, at the time of the MS² analysis the MS² ion amount is integrated in 0.1 second time intervals for storing the result in the memory as needed, and the time dependency information of the MS² ion amount is stored in the hard disc after the MS²being finished. The MS¹ analysis is carried out before and after the MS² analysis. Conventionally, the MS¹ measurement cannot be carried out while executing the MS² so that the quantitative evaluation cannot be enabled in this period. According to the method of this example, since the MS¹ ion time evaluation can be obtained based on both the MS¹ ion amount before and/or after the MS² analysis and the time dependency of the integration amount in the MS² so that the accuracy of the quantitative evaluation can drastically be improved.

### EXAMPLE 9

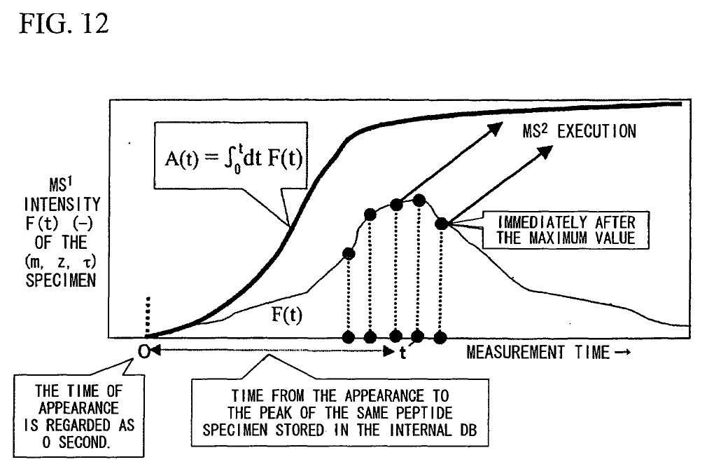

Next, the example 9 of the present invention will be explained with reference to FIG. 12. As shown in FIG. 12, the MS² analysis is carried out immediately after reduction of the ion intensity of the MS¹ with respect to the analysis time when the ion intensity of the MS¹ is increased with respect to the analysis time. Accordingly, by carrying out the MS² analysis at the time of the analysis near the maximum MS¹ intensity, the count number of the MS² analysis is increased so as to improve the analysis sensitivity.

### EXAMPLE 10

Next, the example 10 of the present invention will be explained with reference to FIG. 12. When the time from the appearance of the specimen coinciding with the subject specimen in (m, z, τ) up to its peak occurrence is stored as the time t′ in the internal DB, the MS² analysis is carried out from the time of the appearance of the specimen to t′. By carrying out the MS² analysis at the time of the analysis with the maximum MS¹ intensity, the count number of the MS² analysis is increased so as to improve the analysis sensitivity. Furthermore, in the case the time from the MS¹ to the MS² is δ, by carrying out the MS² analysis when the time elapsed from the appearance of the MS¹ ion is t′-δ, the MS¹ ion intensity can be provided maximally at the time of the real MS² analysis.

### EXAMPLE 11

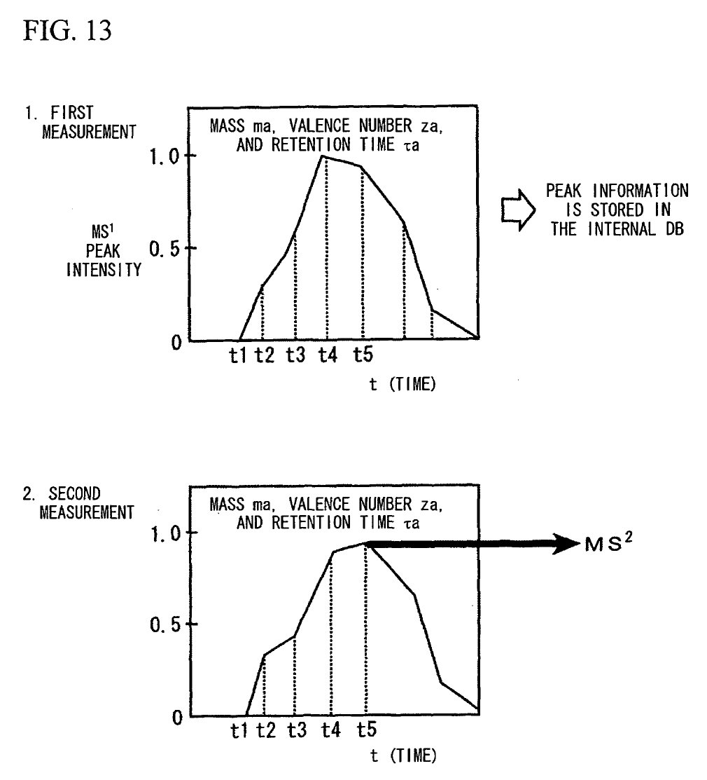

Next, the example 11 of the present invention will be explained with reference to FIG. 13. The MS¹ ion intensity of the peptide C measured on the first time specimen as shown in FIG. 6A is referred to as F₁(t).

With the MS¹ ion intensity of the peptide at the time of measuring the ion of the same mass m, the same valence number z, and the same retention time τ in the second time measurement, being referred to as F₂(t), the following correlation is calculated.

$$r = \frac{{\sum }_{i = 1}^{5} ( {F}_{1} ( {t}_{i} ) - {\overline{F}}_{1} ) ( {F}_{2} ( {t}_{i} ) - {\overline{F}}_{2} )}{\sqrt{\{ {\sum }_{i = 1}^{5} {( {F}_{1} ( {t}_{i} ) - {\overline{F}}_{1} )}^{2} \} \times \{ {\sum }_{i = 1}^{5} {( {F}_{2} ( {t}_{i} ) - {\overline{F}}_{2} )}^{2} \}}} \\ Here , [ Formula ] \\ {\overline{F}}_{1} = \frac{( {F}_{1} ( {t}_{1} ) + {F}_{1} ( {t}_{2} ) + {F}_{1} ( {t}_{3} ) + {F}_{1} ( {t}_{4} ) + {F}_{1} ( {t}_{5} )}{5} \\ {\overline{F}}_{2} = \frac{( {F}_{2} ( {t}_{1} ) + {F}_{2} ( {t}_{2} ) + {F}_{2} ( {t}_{3} ) + {F}_{2} ( {t}_{4} ) + {F}_{2} ( {t}_{5} )}{5} \qquad [ Formula 1 ]$$

is an average value.

Since r is 0.5 or less, the MS² of the peptide is carried out. For the ion intensity, the intensity of the isotope ion is also added. As to the MS² timing, it is carried out immediately after having the MS¹ ion intensity maximum.

### EXAMPLE 12

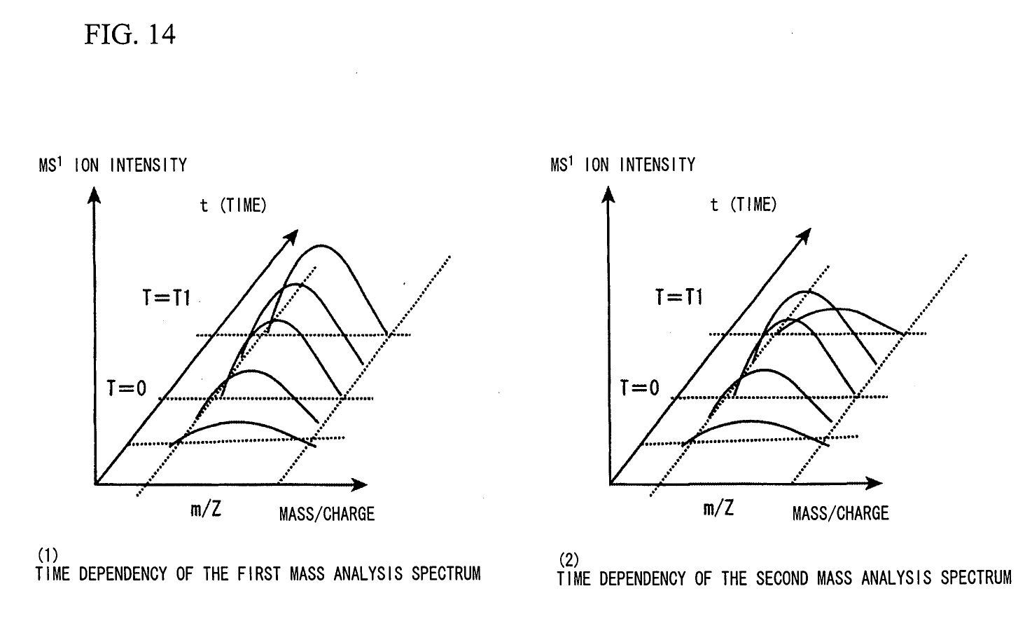

Next, the example 12 of the present invention will be explained with reference to FIG. 14. In this figure, the time dependency of the first mass analysis spectrum of (1) is the mass analysis result of being analyzed presently. Here, the change of the MS¹ mass analysis spectrum (m/z vs MS¹ ion intensity) from the appearance of the ion to the T₁ time thereafter is shown. The m/z range includes the isotope of the ion. The time dependency of the second mass analysis spectrum of (2) is the mass analysis result stored in the database of the apparatus. Here, the change of the MS¹ mass analysis spectrum (m/z vs ion intensity) from the appearance of the ion to the T₁ time thereafter is shown. Here, the valence numbers of the ion species read out from the first analysis spectrum and the above-mentioned second mass analysis spectrum are the same divalent and the masses are of 0.05 Da and the retention times coincide within a 1 minute tolerance. The correlation value of y and z is calculated with the premise that the ion intensity of the first mass analysis is y (t, m/z), and the ion intensity of the second mass analysis is z (t, m/z), to have 0.1, which is smaller than the standard value 0.5, so that the MS² of the above-mentioned ion specie is carried out.

### EXAMPLE 13

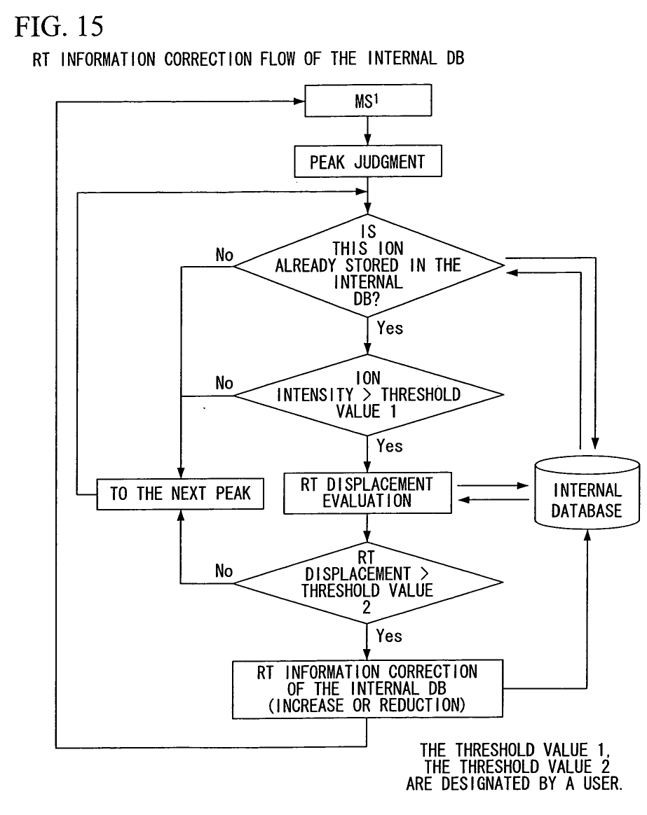

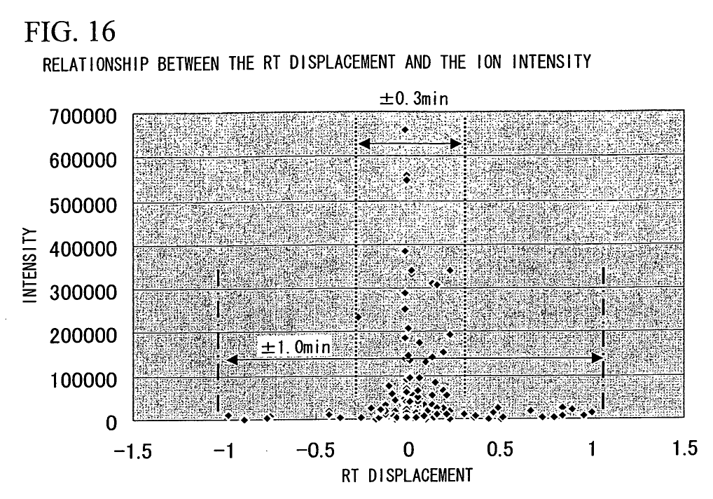

Next, the example 13 of the present invention will be explained with reference to FIGS. 15 and 16. Even in the case of the measurement of the same sample in the same conditions, the results may in general involve variations due to the problems of the reproducibility of the pre-process and the measurement apparatus. Since the retention time is one of the parameters involving variations, it is preferable to correct the same. FIG. 16 is obtained by plotting the degree of variations of the ion specie intensity and the retention time, showing that the degree of variations is smaller for a higher intensity ion. From the above-mentioned, it is preferable to carry out the correction by use of the high intensity peak as an index. As shown in FIG. 15, collation of the peak judged by the MS¹ is carried out with the internal database. In the case of having a high intensity peak among the matching peaks, the correction is carried out based on the detection time of the peak. As shown in FIG. 16, although the high intensity peaks tend to have a small retention time displacement, in the case it is displaced largely, correction should be carried out. In the case of carrying out the correction, the information of the internal database is shifted collectively by the displacement. For example, in the case the real peak is detected with a 5 minute lag with respect to the retention time stored in the internal database, the all retention time information stored in the internal database is increased collectively by 5 minutes (delayed). Thereafter, in the case the displacement rate is changed so that the high intensity peak is detected 3 minutes earlier than the corrected internal database storage value, the storage value of the internal data base is reduced by 3 minutes (advanced). As mentioned above, by modifying the database storage value appropriately each time the designated high intensity peak is detected, the retention time is corrected. Moreover, the threshold value 1 for the high intensity peak judgment and the threshold value 2 of the displacement for correcting the retention time can be designated by the user.

### EXAMPLE 14

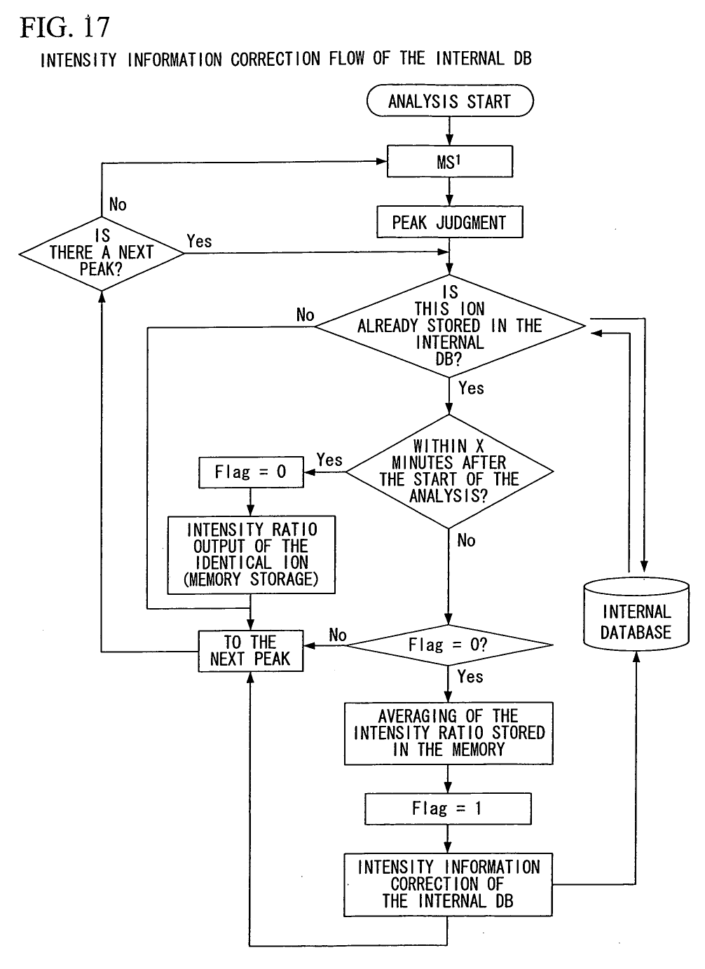

Next, the example 14 of the present invention will be explained with reference to FIG. 17. The ion intensity or integration value judgment is carried out at the time of collation with the internal database, however, depending on the measurement, the concentration of the sample itself to be inputted to the MS may be changed. In this case, even by the comparison with the internal database, most peaks differ in ion intensity, so that the unnecessary MS/MS may be repeated. Therefore, the ion intensity or the integration value stored in the internal database is corrected based on the average ion intensity of the peptide detected in an analysis initial stage. Since the predetermined time X (minute) to be set as the analysis initial stage period at the time is changed also by the analysis total time or the gradient condition of the LC, it can be designated by the user before the analysis. After starting the analysis, if an ion detected within X minutes is an ion already stored in the internal database, the intensity ratio of the totally matching ion is stored in the memory. After passage of the X minutes designated by the user prior to the analysis as the time range for judging the ion intensity correction, the intensity ratio of the ion which has been stored in the memory till the X minutes, is averaged to correct the intensity information of the internal database based thereon. For example, in the case the average intensity of the sample being measured is two times as much as the intensity stored in the internal database, the storage intensity of the internal database is corrected to double. This correction is carried out only once after the passage of the X minutes from the analysis start.

What is claimed is:

1. A mass analysis system comprising a means for ionizing a substance of the measurement subject, a means for selecting an ion specie having a specific mass to charge ratio out of a plurality of ion species, and a means for dissociating an ion specie, and using a tandem type mass analysis apparatus for repeating the ion specie dissociation and the mass measurement by multiple stages, wherein first mass analysis spectrum information measured from the appearance of the measurement subject ion specie until the passage of a predetermined period and second mass analysis spectrum information of the ion specie stored in a database are compared to determine the execution of the dissociation and the mass analysis of the ion specie based on the comparison result.

2. The mass analysis system according to claim 1, wherein the dissociation and the mass analysis of the ion specie are carried out only in the case the correlation between the temporal change of the first mass analysis spectrum and the temporal change of the second mass analysis spectrum is same as or less than a standard value from the comparison result.

3. The mass analysis system according to claim 1, wherein the dissociation and the mass analysis of the ion specie are carried out only in the case the ratio between the total count number or the integration value of the first mass analysis spectrum and the total count number or the integration value of the second mass analysis spectrum is same as or less than a standard value A or same as or more than a standard value B from the comparison result.

4. The mass analysis system according to claim 3, wherein the dissociation and the mass analysis of the ion specie are carried out immediately after having the ion intensity of the first mass analysis spectrum maximally.

5. The mass analysis system according to claim 1, wherein the dissociation and the mass analysis of the ion specie are carried out after passage of the time of having the ion intensity of the second mass analysis spectrum maximally.

6. A mass analysis system comprising a means for ionizing a substance of the measurement subject, a means for selecting an ion specie having a specific mass to charge ratio out of a plurality of ion species, and a means for dissociating an ion specie, and using a tandem type mass analysis apparatus for repeating the ion specie dissociation and the mass measurement by multiple stages, wherein the total ion amount of the dissociated ion specie is measured at predetermined time intervals, and the temporal change of the parent ion amount of the dissociated ion specie is evaluated based on the measurement value.

7. The mass analysis system according to claim 5, wherein the total ion amount of the dissociated ion specie is measured at predetermined intervals in the dissociation and the analysis of the ion specie, the specific value is stored in a memory, and it is stored in a hard disc after passage of a predetermined time.

8. The mass analysis system according to claim 3, wherein the count number or the integration value is a relative value with respect to the total count number or the integration value of another standard ion specie included in the substance as the measurement subject.

9. The mass analysis system according to claim 1, wherein the tandem type mass analysis apparatus is of any type selected from the group consisting of the LIT, the LIT-TOF, the Q-TOF, the TOF-TOF, and the LIT-orbital.

10. The mass analysis system according to claim 1, wherein the means for ionizing a substance of the measurement subject is an ESI or a MALDI.

11. The mass analysis system according to claim 1, wherein the substance of the measurement subject is a living body specimen.

12. The mass analysis system according to claim 1, wherein the first mass analysis spectrum is measured with respect to a patient specimen, and the second mass analysis spectrum is measured with respect to a healthy person specimen.

13. The mass analysis system according to claim 1, wherein the ion specie is an ion included in a peptide, a sugar chain, a chemical molecule, a dioxin, or an explosive.

14. A mass analysis system, wherein in the case the masses of the ion species read out from the first mass analysis spectrum and the second mass analysis spectrum are same and the valence numbers and the retention times are identical to some tolerance, but the correlation or the count total sum differs between the first and second spectra, the dissociation and the mass analysis of the identical ion are carried out.

15. The mass analysis system according to claim 1 or 6, wherein both or one of the spectrum and the voltage at each time halfway through the measurement are stored in the memory and the hard disc as a log.

16. The mass analysis system according to claim 3, wherein the standard value A is 0.5 and the standard value B is 2.

17. The mass analysis system according to claim 1, wherein the retention time information stored in the internal data base is corrected according to the intensity and the detection time of the measured ion specie.

18. The mass analysis system according to claim 1, wherein the coefficient for correcting the ion specie information stored in the internal database is determined automatically based on the ion intensity of an analysis initial stage.

19. The mass analysis system according to claim 18, wherein the analysis initial stage is a certain period from the analysis start, which can be designated by a user as a condition.

20. The mass analysis system according to claim 1, wherein the ion intensity is any one selected from the group consisting of the intensity of a mono isotropic ion, the area of a mono isotopic peak, and the area sum of a mono isotopic peak and an isotope peak.
